(19) United States
(12) Patent Application Publication
(10) Pub. No.: US 2010/0109319 A1
(43) Pub. Date: May 6, 2010

(54) Pipe fittings with a locating claw

(75) Inventors: Hanzhen Zhang, Tianjin (CN); Lei Zhang, Tianjin (CN)

Correspondence Address: ZHEN ZHENG LU, 1730 HUNTINGTON DRIVE #304, DUARTE, CA, 91010, US

(73) Assignee: Tianjin Runshi Science Development Co., Ltd.

(21) Appl. No.: 12/351,866

(22) Filed: Jan. 12, 2009

(30) Foreign Application Priority Data
Nov. 3, 2008 (CN) 200820142896.7

(51) Int. Cl. F16L 55/00

(52) U.S. Cl. 285/93

(57) ABSTRACT

A pipe fittings consists of a joint body, a pipe extension and a locating claw. The pipe fittings is for locating a fastener. The pipe extension extends from the joint body for being received into a plastic pipe. The locating claw mounts outwardly on an outer surface of the joint body, and has an upper portion. The upper portion bends to align with the pipe extension. The upper portion and the pipe extension have a gap therebetween for receiving the plastic pipe. The fastener is located at an outer end of the upper portion to fasten the plastic pipe on the pipe extension. The pipe fittings is standardized to comply with ASTMF2159 standard.

### BACKGROUND OF THE PRESENT INVENTION

1. Field of Invention

The present invention relates to a pipe fittings, and more particularly to a pipe fittings capable of indicating a fastening position of a fastener.

2. Description of Related Arts

Pipes are utilized widely in industry, agriculture and urban construction, e.g., water supply and coal gas supply. The pipe fittings are critical to the reliability and the sealing effect of pipes. Among the new pipes utilized widely in recent years, the plastic pipes (e.g., aluminum plastic pipe, and PEX pipe) and the metal pipes (e.g., thin-walled copper pipe, and thin-walled stainless steel pipe) have many ways to be jointed. For example, the metal fastening ring and the plastic cover are connected by being melted or adhered. However, in this way, the connecting position of the pipe and the metal fastening ring cannot be precisely determined, as shown in FIG. 6,. Besides, the traditional joining ways further have drawbacks such as inconvenient operation, bad sealing effect, insecure connection and high cost.

### SUMMARY OF THE PRESENT INVENTION

An object of the present invention is to provide pipe fittings, which is capable of indicating a fastening position. Particularly, the pipe fittings couples with a fastener, and solves the problem that the prior art can not point out the fastening position of the fastener, and therefore the fastener is fastened at an optimal position. The pipe fittings joins the pipes up with convenient operation and accurate location, and the pipes are joined tightly, so as to have good sealing effect and high assembly efficiency.

Accordingly, in order to accomplish the above objects, the present invention provides a pipe fittings for locating a fastener, consisting of:

a joint body;

a pipe extension extending from the joint body; and

a locating claw extending outwardly on an outer surface of the joint body, and having an upper portion bending to align with the pipe extension, wherein the upper portion and the pipe extension have a gap therebetween for receiving a wall of a plastic pipe, and the fastener is located at an outer end of the upper portion, so as to fasten the plastic pipe on the pipe extension at an optimal fastening position.

Therefore the locating claw indicates the optimal fastening position for the fastener to enhance a sealing effect, and connecting tightness can be observed during the fastening process.

The upper portion of the locating claw has a length of 3.2˜6.4 mm.

The pipe fittings comprises one or more locating claws for locating the fastening position of the fastener.

The pipe extension has a straight inner channel, and has a plurality of first grooves I and corresponding convex plates provided on an outer surface thereof. The first grooves I and the convex plates have width and depth matching with a standardized PEX pipe.

The upper portion of the locating claw has an inclined inner wall and an outer wall. The outer wall has a second groove II provided thereon. The outer wall and the inner wall form a trapezoidal section.

The fastener is preferably embodied as a copper ring or a stainless steel clamp. The copper ring is preferred as a copper ring complying with ASTMF1807, and the stainless steel clamp is preferred as a stainless steel clamp complying with ASTMF2098.

The pipe fittings according to the present invention can be embodied as a straight through pipe fittings, a three-way pipe fittings, an elbow pipe fittings or a valve.

The plastic pipe is preferably embodied as a PEX pipe.

A method of assembling a pipe fittings comprises the steps of:

inserting a pipe extension into a PEX pipe until an end of the PEX pipe enters into a gap defined between an upper portion of a locating claw and the pipe extension to reach the locating claw;

mounting a fastener on the PEX pipe, wherein the fastener is next to an outer end of the upper portion; and

fastening the fastener with a tool, wherein being located by the locating claw, the fastener couples with convex plates of the pipe extension to fasten the PEX pipe and the pipe fittings.

The present invention has the following advantages:

1. The pipe fittings complies with ASTMF2159 standard, and is suitable to couple with different fasteners such as a stainless steel clamp complying with ASTMF2098 and a copper ring complying with ASTMF1807.

2. The pipe fittings comprises an integral locating claw for determining a connecting position of a PEX pipe and a fastener, so as to lower cost.

3. The connecting tightness of a PEX pipe and the pipe fittings is easy to be observed during the assembling process, so as to increase overall quality of the connected pipes.

4. The locating claw has a space for receiving the pipe and an inclined inner wall, so that when fastening the fastener, the upper portion can bend downwardly, and the locating claw is prevented from being damaged.

5. The locating claw according to the present invention is applicable to various pipe fittings and valves.

6. The pipe fittings has standardized structure, and is capable of being utilized in connecting different pipes with the pipe fittings of different styles, so that the pipe fittings is easy to be assembled, and to be utilized widely in the installation works of industrial or civil water supply and coal gas supply.

These and other objectives, features, and advantages of the present invention will become apparent from the following detailed description, the accompanying drawings, and the appended claims.

### BRIEF DESCRIPTION OF THE DRAWINGS

FIG. 1A is a front view of a pipe fittings according to a first preferred embodiment of the present invention.

FIG. 1B is a left side view of the pipe fittings according to the first preferred embodiment of the present invention.

FIG. 2A is a front view of a pipe fittings according to a second preferred embodiment of the present invention.

FIG. 2B is a left side view of the pipe fittings according to the second preferred embodiment of the present invention.

FIG. 3A is a front view of a pipe fittings according to a third preferred embodiment of the present invention.

FIG. 3B is a left side view of the pipe fittings according to the third preferred embodiment of the present invention.

FIG. 4A is a sectional view of a fastening ring according to a preferred embodiment of the present invention.

FIG. 4B is a radial view of a fastening clamp according to a preferred embodiment of the present invention.

FIG. 4C is an axial view of the fastening clamp according to the preferred embodiment of the present invention.

FIG. 5A is a sectional view of a connected unit of a PEX pipe, the pipe fittings and the fastener, illustrating the fastening ring mounting on the pipe extension before being fastened.

FIG. 5B is a sectional view of the connected unit of the PEX pipe, the pipe fittings and the fastener, illustrating the fastening ring mounting on the pipe extension after being fastened.

FIG. 5C is a sectional view of the connected unit of the PEX pipe, the pipe fittings and the fastener, illustrating the fastening clamp mounting on the pipe extension before being fastened.

FIG. 5D is a sectional view of the connected unit of the PEX pipe, the pipe fittings and the fastener, illustrating the fastening clamp mounting on the pipe extension after being fastened.

FIG. 6 is a sectional view of a connected unit of a PEX pipe, a conventional pipe fittings and a fastener, illustrating a connecting way of the conventional pipe fittings according to the prior art.

### DETAILED DESCRIPTION OF THE PREFERRED EMBODIMENT

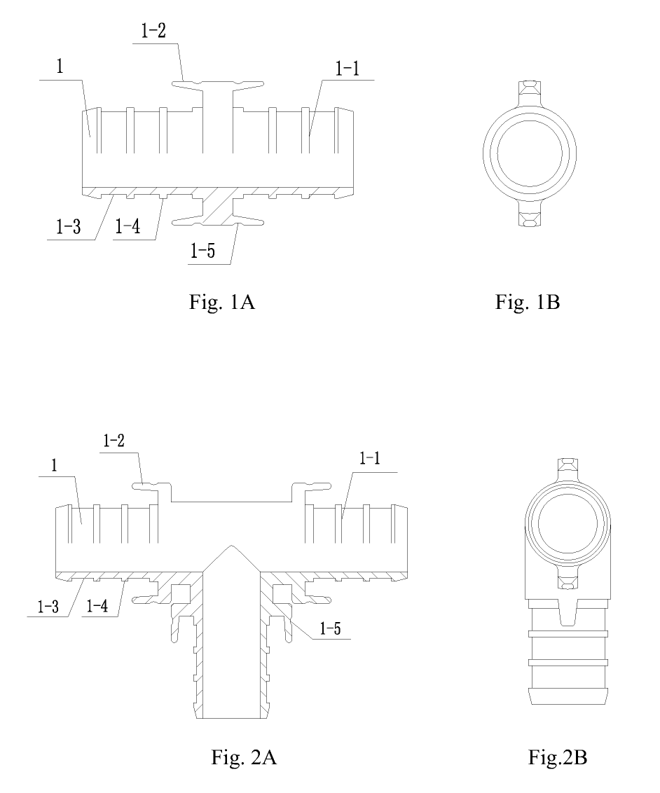

Referring to FIG. 1-5 of the drawings, a pipe fittings according to a first preferred embodiment of the present invention is illustrated, consisting of a joint body 1, a pipe extension 1-1 and a locating claw 1-2.

The pipe fittings is for locating a fastener. The pipe extension 1-1 extends from the joint body 1 for being received into a plastic pipe 3.

The locating claw 1-2 mounts outwardly on an outer surface of the joint body 1, and has an upper portion. The upper portion bends to align with the pipe extension 1-1. The upper portion and the pipe extension 1-1 have a gap therebetween for receiving the plastic pipe 3. The fastener is located at an outer end of the upper portion to fasten the plastic pipe 3 on the pipe extension 1-1.

The upper portion of the locating claw 1-2 has a length of 3.5 mm.

The pipe fittings comprises two locating claws 1-2 for locating a fastening position of the fastener.

The pipe extension 1-1 has a straight inner channel, and has a plurality of first grooves I 1-3 and corresponding convex plates 1-4 provided on an outer surface thereof. The first grooves I 1-3 and the convex plates 1-4 have width and depth matching with a standardized PEX pipe.

The upper portion of the locating claw 1-2 has an inclined inner wall and an outer wall. The outer wall has a second groove II 1-5 provided thereon. The outer wall and the inner wall form a trapezoidal section.

The pipe fittings is preferably embodied as a straight through pipe fittings.

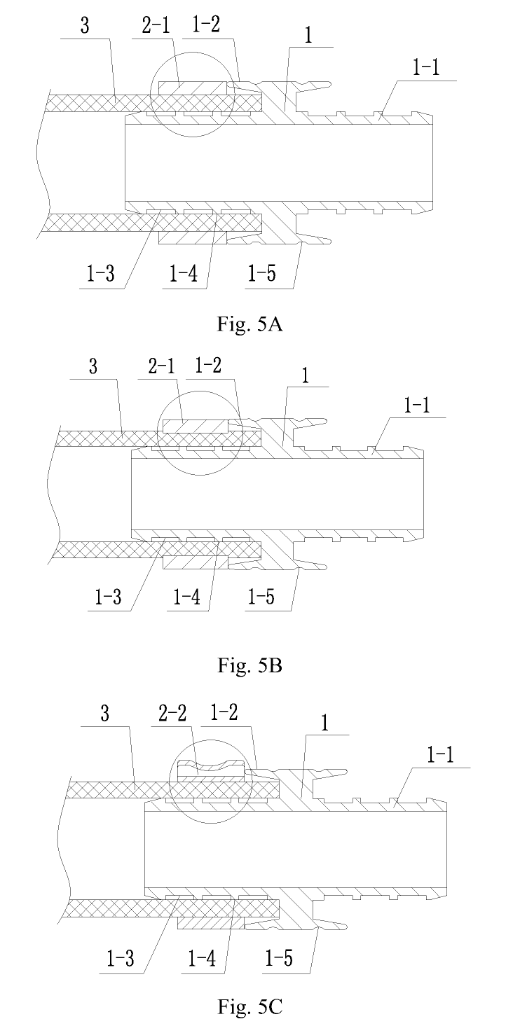

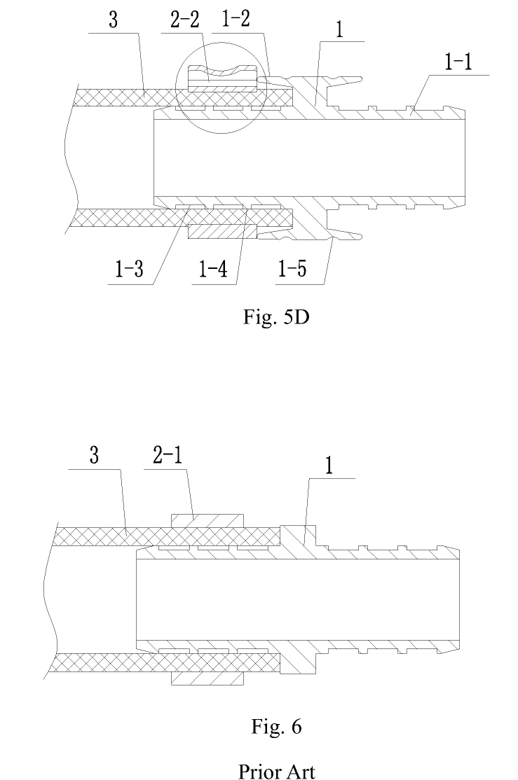

Referring to FIG. 4A, FIG. 5A and FIG. 5B, the fastener is preferably embodied as a copper ring 2-1 complying with ASTMF1807.

Referring to FIG. 1 of the drawings, a pipe fittings according to a second preferred embodiment of the present invention is illustrated, consisting of a joint body 1, a pipe extension 1-1 and a locating claw 1-2.

The pipe fittings is for locating a fastener. The pipe extension 1-1 extends from the joint body 1 for being received into a plastic pipe 3.

The locating claw 1-2 mounts outwardly on an outer surface of the joint body 1, and has an upper portion. The upper portion bends to align with the pipe extension 1-1. The upper portion and the pipe extension 1-1 have a gap therebetween for receiving the plastic pipe 3. The fastener is located at an outer end of the upper portion to fasten the plastic pipe 3 on the pipe extension 1-1.

The upper portion of the locating claw 1-2 has a length of 4.1 mm.

The pipe fittings comprises two locating claws 1-2 for locating a fastening position of the fastener.

The pipe extension 1-1 has a straight inner channel, and has a plurality of first grooves I 1-3 and corresponding convex plates 1-4 provided on an outer surface thereof. The first grooves I 1-3 and the convex plates 1-4 have width and depth matching with a standardized PEX pipe.

The upper portion of the locating claw 1-2 has an inclined inner wall and an outer wall. The outer wall has a second groove II 1-5 provided thereon. The outer wall and the inner wall form a trapezoidal section.

The pipe fittings is preferably embodied as a straight through pipe fittings.

Referring to FIG. 4B, FIG. 4C, FIG. 5C and FIG. 5D, the fastener is preferably embodied as a stainless steel clamp 2-2 complying with ASTMF2098.

Referring to FIG. 2 of the drawings, a pipe fittings according to a third preferred embodiment of the present invention is illustrated, consisting of a joint body 1, a pipe extension 1-1 and a locating claw 1-2.

The pipe fittings is for locating a fastener. The pipe extension 1-1 extends from the joint body 1 for being received into a plastic pipe 3.

The locating claw 1-2 mounts outwardly on an outer surface of the joint body 1, and has an upper portion. The upper portion bends to align with the pipe extension 1-1. The upper portion and the pipe extension 1-1 have a gap therebetween for receiving the plastic pipe 3. The fastener is located at an outer end of the upper portion to fasten the plastic pipe 3 on the pipe extension 1-1.

The upper portion of the locating claw 1-2 has a length of 6 mm.

The pipe fittings comprises two locating claws 1-2 for locating a fastening position of the fastener.

The pipe extension 1-1 has a straight inner channel, and has a plurality of first grooves I 1-3 and corresponding convex plates 1-4 provided on an outer surface thereof. The first grooves I 1-3 and the convex plates 1-4 have width and depth matching with a standardized PEX pipe.

The upper portion of the locating claw 1-2 has an inclined inner wall and an outer wall. The outer wall has a second groove II 1-5 provided thereon. The outer wall and the inner wall form a trapezoidal section.

The pipe fittings is preferably embodied as a three-way pipe fittings.

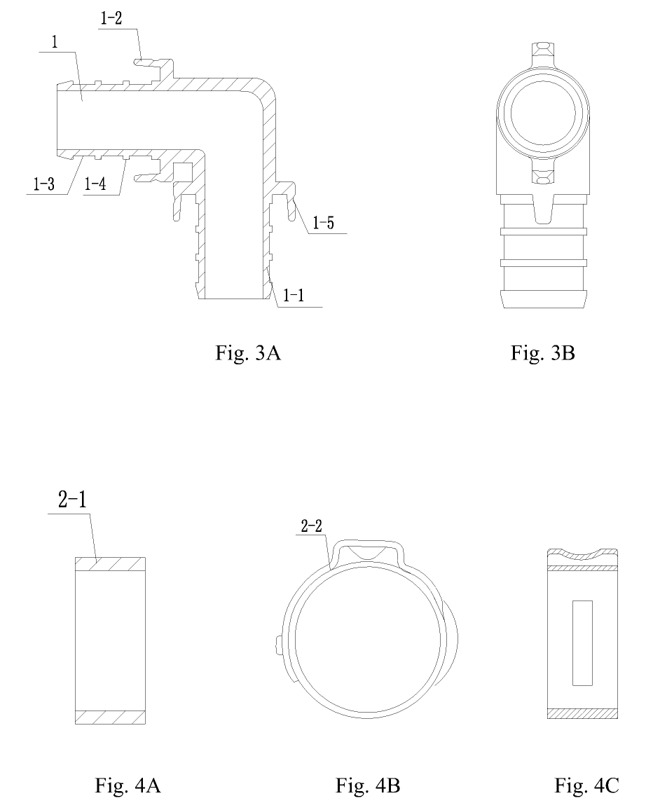

Referring to FIG. 3 of the drawings, a pipe fittings according to a third preferred embodiment of the present invention is illustrated, consisting of a joint body 1, a pipe extension 1-1 and a locating claw 1-2.

The pipe fittings for locating a fastener. The pipe extension 1-1 extends from the joint body 1 for being received into a plastic pipe 3.

The locating claw 1-2 mounts outwardly on an outer surface of the joint body 1, and has an upper portion. The upper portion bends to align with the pipe extension 1-1. The upper portion and the pipe extension 1-1 have a gap therebetween for receiving the plastic pipe 3. The fastener is located at an outer end of the upper portion to fasten the plastic pipe 3 on the pipe extension 1-1.

The upper portion of the locating claw 1-2 has a length of 5.2 mm.

The pipe fittings comprises two locating claws 1-2 for locating a fastening position of the fastener.

The pipe extension 1-1 has a straight inner channel, and has a plurality of first grooves I 1-3 and corresponding convex plates 1-4 provided on an outer surface thereof. The first grooves I 1-3 and the convex plates 1-4 have width and depth matching with a standardized PEX pipe.

The upper portion of the locating claw 1-2 has an inclined inner wall and an outer wall. The outer wall has a second groove II 1-5 provided thereon. The outer wall and the inner wall form a trapezoidal section.

The pipe fittings is preferably embodied as an elbow pipe fittings.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1-20. (canceled)

21. A pipe fitting, comprising:
a joint body;
a pipe extension extending from said joint body for being received into a plastic pipe; and
at least a locating claw extending outwardly on an outer surface of said joint body and having an upper portion bending to align with said pipe extension, wherein said upper portion and said pipe extension have a gap therebetween for receiving a wall of the plastic pipe, and said pipe extension is coated by the plastic pipe, wherein said upper portion has a predetermined length shorter than said pipe extension, so that said upper portion indicates an optimal position at an outer end thereof for mounting a fastener on the plastic pipe to fasten the plastic pipe between the fastener and said pipe extension.

22. The pipe fitting, as recited in claim 21, wherein said upper portion has a length of 3.2-6.4 mm.

23. The pipe fitting, as recited in claim 21, wherein said pipe extension has a straight inner channel, and has a plurality of first grooves and corresponding convex plates provided on an outer surface thereof, wherein said first grooves and said convex plates have width and depth matching with a standardized PEX pipe according to ANSI/ASTM F876 (Standard Specification for Crosslinked Polyethylene (PEX) Tubing).

24. The pipe fitting, as recited in claim 22, wherein said pipe extension has a straight inner channel, and has a plurality of first grooves and corresponding convex plates provided on an outer surface thereof, wherein said first grooves and said convex plates have width and depth matching with a standardized PEX pipe according to ANSI/ASTM F876 (Standard Specification for Crosslinked Polyethylene (PEX) Tubing).

25. The pipe fitting, as recited in claim 21, wherein said pipe fitting comprises plural locating claws for locating the fastening positions of plural corresponding fasteners.

26. The pipe fitting, as recited in claim 22, wherein said pipe fitting comprises plural locating claws for locating the fastening positions of plural corresponding fasteners.

27. The pipe fitting, as recited in claim 24, wherein said pipe fitting comprises plural locating claws for locating the fastening positions of plural corresponding fasteners.

28. The pipe fitting, as recited in claim 21, wherein said locating claw has an inclined inner wall, and an outer wall which has a second groove provided thereon, wherein said inner wall and said outer wall form a trapezoidal section.

29. The pipe fitting, as recited in claim 22, wherein said locating claw has an inclined inner wall, and an outer wall which has a second groove provided thereon, wherein said inner wall and said outer wall form a trapezoidal section.

30. The pipe fitting, as recited in claim 23, wherein said locating claw has an inclined inner wall, and an outer wall which has a second groove provided thereon, wherein said inner wall and said outer wall form a trapezoidal section.

31. The pipe fitting, as recited in claim 25, wherein said locating claw has an inclined inner wall, and an outer wall which has a second groove provided thereon, wherein said inner wall and said outer wall form a trapezoidal section.

32. The pipe fitting, as recited in claim 27, wherein said locating claw has an inclined inner wall, and an outer wall which has a second groove provided thereon, wherein said inner wall and said outer wall form a trapezoidal section.

33. The pipe fitting, as recited in claim 21, wherein said pipe fitting is standardized for coupling with a fastener selecting from the group consisting of a copper ring complying with ASTMF1807 (Standard Specification for Metal Insert Fittings Utilizing a Copper Crimp Ring for SDR9 Cross-linked Polyethylene (PEX) Tubing), and a stainless steel clamp complying with ASTMF2098 (Standard Specification for Stainless Steel Clamps for Securing SDR9 Cross-linked Polyethylene (PEX) Tubing to Metal Insert Fittings).

34. The pipe fitting, as recited in claim 22, wherein said pipe fitting is standardized for coupling with a fastener selecting from the group consisting of a copper ring complying with ASTMF1807 (Standard Specification for Metal Insert Fittings Utilizing a Copper Crimp Ring for SDR9 Cross-linked Polyethylene (PEX) Tubing), and a stainless steel clamp complying with ASTMF2098 (Standard Specification for Stainless Steel Clamps for Securing SDR9 Cross-linked Polyethylene (PEX) Tubing to Metal Insert Fittings).

35. The pipe fitting, as recited in claim 23, wherein said pipe fitting is standardized for coupling with a fastener selecting from the group consisting of a copper ring complying with ASTMF1807 (Standard Specification for Metal Insert Fittings Utilizing a Copper Crimp Ring for SDR9 Cross-linked Polyethylene (PEX) Tubing), and a stainless steel clamp complying with ASTMF2098 (Standard Specification for Stainless Steel Clamps for Securing SDR9 Cross-linked Polyethylene (PEX) Tubing to Metal Insert Fittings).

36. The pipe fitting, as recited in claim 25, wherein said pipe fitting is standardized for coupling with a fastener selecting from the group consisting of a copper ring complying with ASTMF1807 (Standard Specification for Metal Insert Fittings Utilizing a Copper Crimp Ring for SDR9 Cross-linked Polyethylene (PEX) Tubing), and a stainless steel clamp complying with ASTMF2098 (Standard Specification for Stainless Steel Clamps for Securing SDR9 Cross-linked Polyethylene (PEX) Tubing to Metal Insert Fittings).

37. The pipe fitting, as recited in claim 32, wherein said pipe fitting is standardized for coupling with a fastener selecting from the group consisting of a copper ring complying with ASTMF1807 (Standard Specification for Metal Insert Fittings Utilizing a Copper Crimp Ring for SDR9 Cross-linked Polyethylene (PEX) Tubing), and a stainless steel clamp complying with ASTMF2098 (Standard Specification for Stainless Steel Clamps for Securing SDR9 Cross-linked Polyethylene (PEX) Tubing to Metal Insert Fittings).

38. The pipe fitting, as recited in claim 21, wherein said pipe fitting is a member selected from the group consisting of a straight through pipe fitting, a three-way pipe fitting, and an elbow pipe fitting.

39. The pipe fitting, as recited in claim 37, wherein said pipe fitting is a member selected from the group consisting of a straight through pipe fitting, a three-way pipe fitting, and an elbow pipe fitting.

40. A method of assembling a pipe fitting, comprising the steps of:
inserting a pipe extension into a PEX pipe until an end of the PEX pipe enters into a gap defined between an upper portion of a locating claw and the pipe extension to reach the locating claw which connects with the pipe extension, wherein the upper portion is shorter than the pipe extension to remain a space over the pipe extension;
mounting a fastener on the PEX pipe via the space at an outer end of the upper portion; and
fastening the fastener to clamp the PEX pipe between the fastener and the pipe extension, wherein a fastening position of the fastener is located by the locating claw, and the fastener couples with convex plates of the pipe extension to fasten the PEX pipe and the pipe fitting.
